(19) United States
(12) Patent Application Publication
(10) Pub. No.: US 2024/0129686 A1
(43) Pub. Date: Apr. 18, 2024

(54) DISPLAY CONTROL APPARATUS, AND DISPLAY CONTROL METHOD

(71) Applicants: Pixie Dust Technologies, Inc., Tokyo (JP); Sumitomo Pharma Co., Ltd., Osaka-shi, Osaka (JP)

(72) Inventors: Megumi TABATA, Tokyo (JP); Haruki NISHIMURA, Tokyo (JP); Akira ENDO, Tokyo (JP); Yasuhiro HABARA, Tokyo (JP); Masaki GOMI, Tokyo (JP); Yudai TAIRA, Tokyo (JP)

(73) Assignees: Pixie Dust Technologies, Inc., Tokyo (JP); Sumitomo Pharma Co., Ltd., Osaka (JP)

(21) Appl. No.: 18/545,081

(22) Filed: Dec. 19, 2023

Related U.S. Application Data
(63) Continuation of application No. PCT/JP2022/024486, filed on Jun. 20, 2022.

(30) Foreign Application Priority Data
Jun. 21, 2021 (JP) 2021-102245

(51) Int. Cl. H04S 7/00

(52) U.S. Cl. CPC H04S 7/303; H04R 3/005; H04S 2400/11

(57) ABSTRACT

A display control apparatus for controlling display of a display device that a user can wear acquires speech collected by a plurality of microphones, estimates a sound-arrival direction of the acquired speech, and generates a text image corresponding to the acquired speech. The display control apparatus determines an adjustment amount of a display position of the text image on the display unit of the display device based on a detection result of at least one of an operation by the user and a state of the display device. Then, the display control apparatus displays the generated text image at a display position in the display unit, the display position being determined in accordance with the estimated sound-arrival direction and the determined adjustment amount.

### CROSS-REFERENCE TO RELATED APPLICATIONS

This application is a Continuation application of No. PCT/JP2022/24486, filed on Jun. 20, 2022, and the PCT application is based upon and claims the benefit of priority from Japanese Patent Application No. 2021-102245, filed on Jun. 21, 2021, the entire contents of which are incorporated herein by reference.

### FIELD

The present disclosure relates to a display control apparatus, a display control method, and a program.

### BACKGROUND

A hearing-impaired person may have a reduced ability to capture the arrival direction of sound due to a reduced auditory function. When such a hard-of-hearing person tries to have a conversation with a plurality of persons, it is difficult for the hard-of-hearing person to accurately recognize who is speaking what, and communication is hindered.

Japanese Patent Application Laid-Open No. 2007-334149 discloses a head-mounted display device for assisting a hearing-impaired person in recognizing ambient sound. This device allows the wearer to visually recognize the ambient sound by displaying a result of speech recognition performed on the ambient sound received by using a plurality of microphones as character information in a part of the visual field of the wearer.

To provide a display method which is highly convenient for a user in a display device which displays a text image corresponding to voice within a visual field of the user. For example, when a text image generated by speech recognition is displayed such that the displayed image overlaps the face of the conversation partner in the field of view of the user, the user cannot read the facial expression of the conversation partner, and smooth communication is hindered.

### SUMMARY

An object of the present disclosure is to provide a display method that is highly convenient for a user in a display device that displays a text image corresponding to a voice within a visual field of the user.

### BRIEF DESCRIPTION OF THE DRAWINGS

FIG. 1 is a diagram showing a configuration example of a display device.

FIG. 2 is a diagram showing an outline of a display device.

FIG. 3 illustrates the functionality of the display device.

FIG. 4 is a flowchart showing an example of processing of a controller.

FIG. 5 is a diagram for explaining sound collection by a microphone.

FIG. 6 is a diagram for explaining an arrival direction of a sound.

FIG. 7 is a diagram showing a display example in a display device.

FIG. 8 is a diagram for explaining how the wearer looks in the field of view.

FIG. 9A is a diagram for explaining how the wearer looks in the field of view before adjustment of a display position.

FIG. 9B is a diagram for explaining how the wearer looks in the field of view before adjustment of a display position.

FIG. 10A is a diagram for explaining how the wearer looks in the field of view after adjustment of a display position.

FIG. 10B is a diagram for explaining how the wearer looks in the field of view after adjustment of a display position.

FIG. 11A is a diagram showing an example of a method of adjusting a display position.

FIG. 11B is a diagram showing an example of a method of adjusting a display position.

FIG. 11C is a diagram showing an example of a method of adjusting a display position.

FIG. 12 is a flowchart illustrating an example of processing related to adjustment of a display position.

FIG. 13 is a diagram for explaining a method of designating an adjustment target of a display position.

### DETAILED DESCRIPTION

Hereinafter, an embodiment of the present disclosure will be described in detail with reference to the drawings. In the drawings for describing the embodiments, the same constituent elements are denoted by the same reference numerals in principle, and repeated description thereof will be omitted.

A display control apparatus according to the present disclosure has, for example, the following configuration. There is provided a display control apparatus for controlling display of a display device wearable by a user, the display control apparatus including: an acquisition unit configured to acquire speech collected by a plurality of microphones; an estimation unit configured to estimate a sound-arrival direction of the speech acquired by the acquisition unit; a determination unit configured to determine an adjustment amount of a display position of the text image on a display unit of the display device based on a detection result of at least one of a user operation and a state of the display device; and a display control unit configured to display the text image generated by the generation unit at a display position in the display unit, the display position being determined according to the sound-arrival direction estimated by the estimation unit and the adjustment amount determined by the determination unit.

### (1) Configuration of Information Processing Apparatus

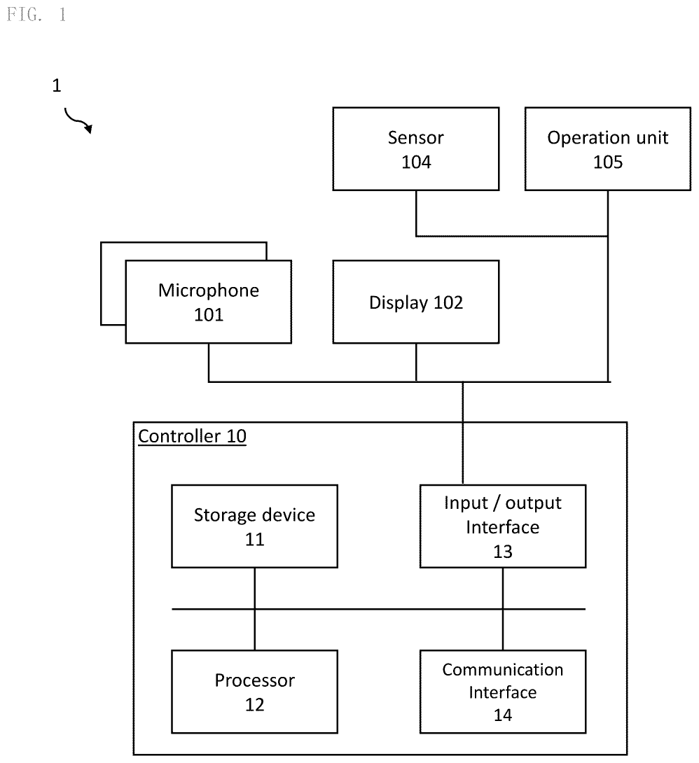

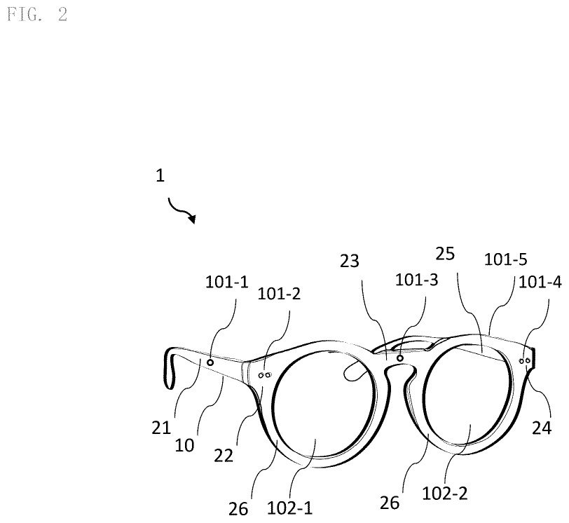

The configuration of the display device 1 of the present embodiment will be described. FIG. 1 is a diagram illustrating a configuration example of a display device. FIG. 2 is a diagram showing an outline of a glass type display device which is an example of the display device shown in FIG. 1.

The display device 1 illustrated in FIG. 1 is configured to collect sound and to display a text image corresponding to the collected sound in an aspect corresponding to a sound-arrival direction of the speech.

Aspects of the display device 1 include, for example, at least one of the following:
Glass type display device;
Head-mounted display; and
Portable terminal.

As shown in FIG. 1, the display device 1 includes a plurality of microphones 101, a display 102, a sensor 104, an operation unit 105, and a controller 10.

The microphones 101 are arranged so as to maintain a predetermined positional relationship with each other.

As shown in FIG. 2, when the display device 1 is a glass type display device, the display device 1 includes a right temple 21, a right endpiece 22, a bridge 23, a left endpiece 24, a left temple 25, and a rim 26, and can be worn by a user.

The microphone 101-1 is disposed on the right temple 21.

The microphone 101-2 is disposed on the right endpiece 22.

The microphone 101-3 is disposed in the bridge 23.

The microphone 101-4 is disposed on the left endpiece 24.

The microphone 101-5 is disposed on the left temple 25.

The number and arrangement of the microphones 101 in the display device 1 are not limited to the example of FIG. 2.

The microphone 101 collects, for example, sound around the display device 1. The sound collected by the microphone 101 includes, for example, at least one of the following sounds:
Speech sound by a person; and
Sound of environment in which the display device 1 is used (hereinafter referred to as “environmental sound”)

When the display device 1 is a glass type display device, the display 102 is a member having transparency (for example, at least one of glass, plastic, and a half mirror). In this case, the display 102 is located within the field of view of the user wearing the glass type display device.

The displays 102-1 to 102-2 are supported by the rim 26. The display 102-1 is disposed so as to be located in front of the right eye of the user when the user wears the display device 1. The display 102-2 is disposed so as to be located in front of the left eye of the user when the user wears the display device 1.

The display 102 presents (for example, displays) an image under the control of the controller 10. For example, an image is projected onto the display 102-1 from a projector (not shown) disposed on the back side of the right temple 21, and an image is projected onto the display 102-2 from a projector (not shown) disposed on the back side of the left temple 25. Thus, the display 102-1 and the display 102-2 present images. The user can visually recognize not only the image but also scenery transmitted through the display 102-1 and the display 102-2.

Note that the method by which the display device 1 presents an image is not limited to the above example. For example, the display device 1 may directly project an image from a projector to the user's eye.

The sensor 104 detects a state of the display device 1. For example, the sensor 104 includes a gyro sensor or an inclination sensor, and detects the inclination of the display device 1 in the elevation angle direction. However, the type of the sensor 104 and the content of the detected state are not limited to this example.

The operation unit 105 receives an operation by a user. The operation unit 105 is, for example, a drive button, a keyboard, a pointing device, a touch panel, a remote controller, a switch, or a combination thereof, and detects a user operation on the display device 1. However, the type of the operation unit 105 and the content of the detected operation are not limited to this example.

The controller 10 is an information processing apparatus that controls the display device 1. The controller 10 is connected to the microphone 101, the display 102, the sensor 104, and the operation unit 105 in a wired or wireless manner.

When the display device 1 is a glass type display device as shown in FIG. 2, the controller 10 is disposed, for example, inside the right temple 21. However, the arrangement of the controller 10 is not limited to the example of FIG. 2, and for example, the controller 10 may be configured as a separate body from the display device 1.

As shown in FIG. 1, the controller 10 includes a storage device 11, a processor 12, an input/output interface 13, and a communication interface 14.

The storage device 11 is configured to store programs and data. The storage device 11 is, for example, a combination of a read only memory (ROM), a random access memory (RAM), and a storage (for example, a flash memory or a hard disk).

The program includes, for example, the following programs:
Program of OS (Operating System); and
Program of application for executing information processing.

The data includes, for example, the following data:
Database referred to in information processing; and
Data obtained by executing information processing (that is, an execution result of the information processing).

The processor 12 is configured to realize the function of the controller 10 by running the program stored in the storage device 11. The processor 12 is an example of a computer. For example, the processor 12 activates a program stored in the storage device 11 to realize a function of presenting an image representing a text corresponding to a speech sound collected by the microphone 101 (hereinafter referred to as a “text image”) at a predetermined position on the display 102. Note that the display device 1 may include dedicated hardware such as an ASIC or an FPGA, and at least a part of the processing of the processor 12 described in the present embodiment may be executed by the dedicated hardware.

The input/output interface 13 acquires at least one of the following:
Speech signal collected by microphone 101;
Information indicating the state of the display device 1 detected by the sensor 104; and
Input in response to a user operation received by the operation unit 105.

The input/output interface 13 is also configured to output information to an output device connected to the display device 1. The output device is, for example, the display 102.

The communication interface 14 is configured to control communication between the display device 1 and an external device (for example, a server or a mobile terminal) which is not illustrated.

### (2) Outline of Function

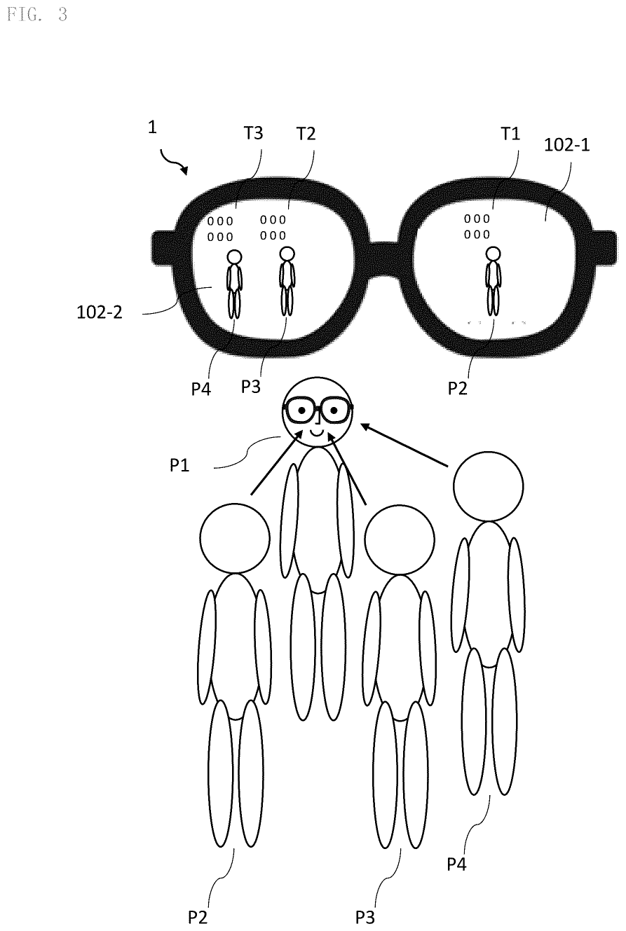

An outline of functions of the display device 1 according to the present embodiment will be described. FIG. 3 illustrates the functionality of the display device.

In FIG. 3, the user P1 wearing the display device 1 has a conversation with speakers P2 to P4.

The microphone 101 collects speech sounds of the speakers P2 to P4.

The controller 10 estimates a sound-arrival direction of the collected speech sound.

The controller 10 generates text images T1 to T3 corresponding to the speech sound by analyzing a speech signal corresponding to the collected speech sound.

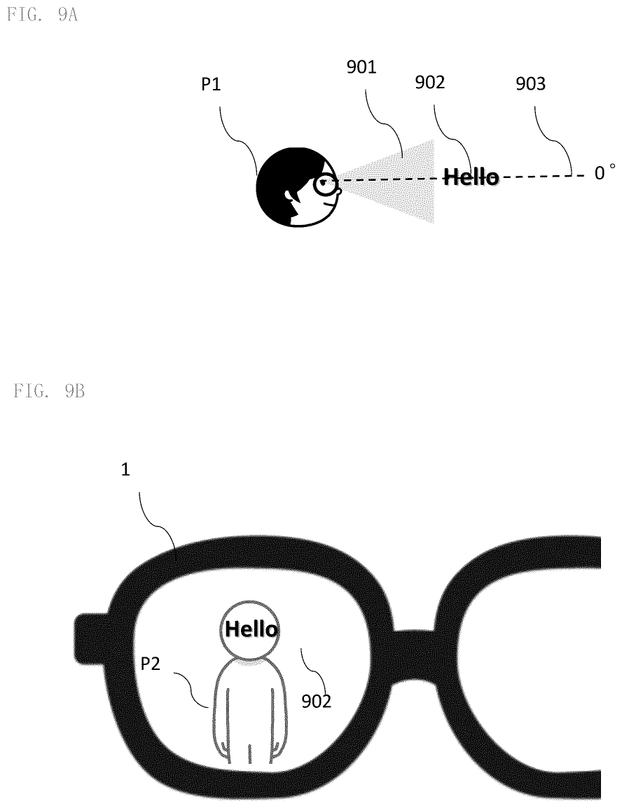

For each of the text images T1 to T3, the controller 10 determines the display position according to the sound-arrival direction of the speech sound and the adjustment amount determined based on the input from the sensor 104 or the operation unit 105. Details of a method of determining the display position will be described later with reference to FIGS. 9 to 13 and the like.

The controller 10 displays the text images T1 to T3 at the determined display positions in the displays 102-1 to 102-2.

### (3) Processing of the Controller 10

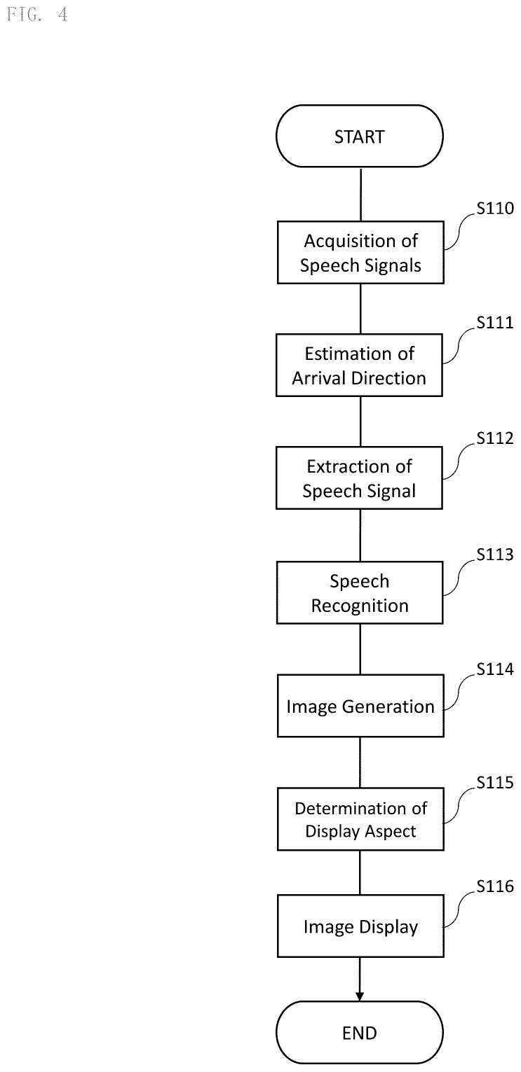

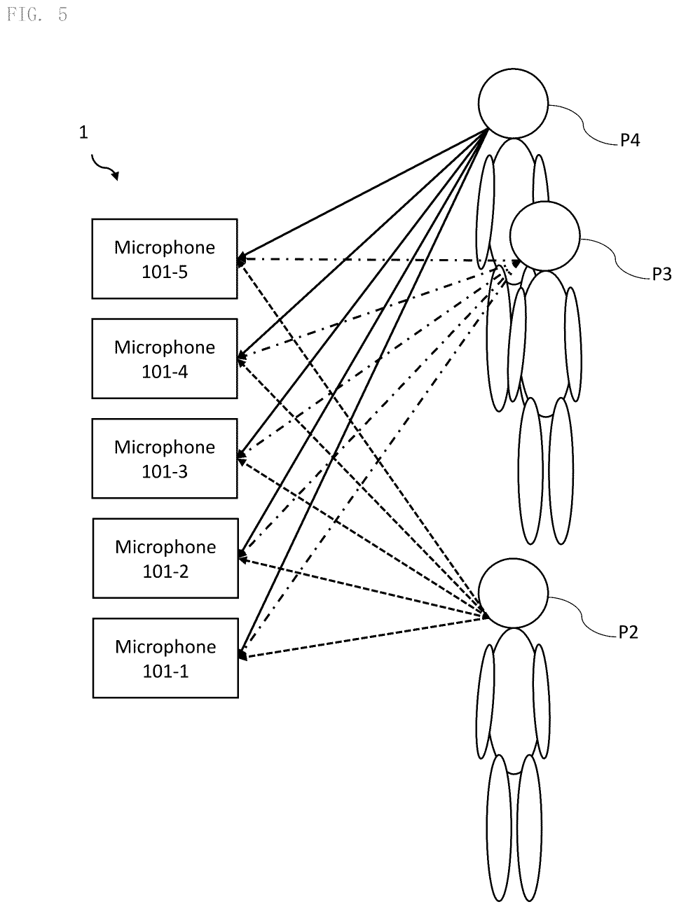

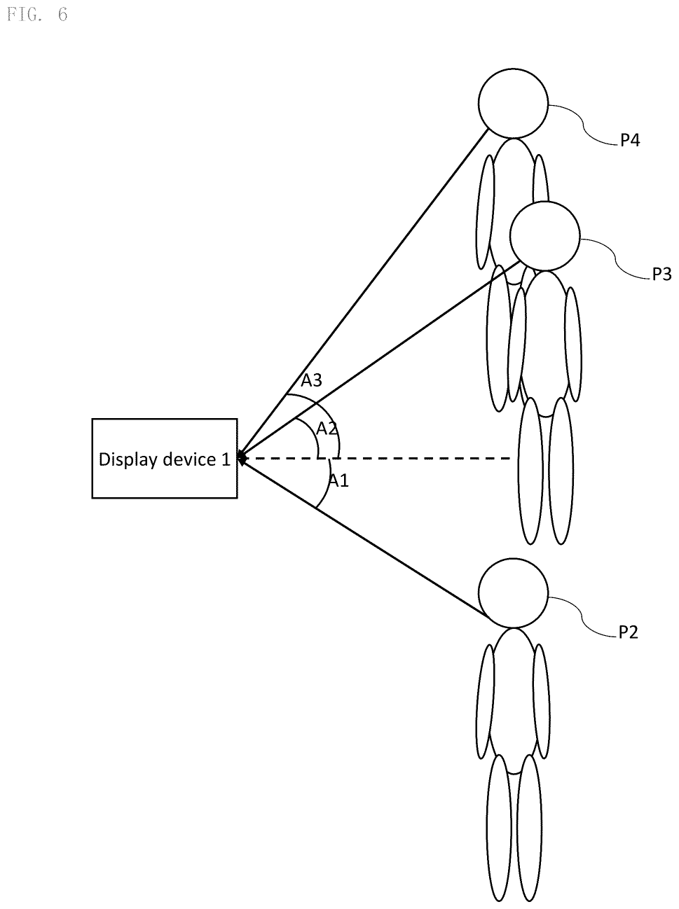

FIG. 4 is a flowchart illustrating an example of a process of the controller 10. FIG. 5 is a diagram for explaining sound collection by a microphone. FIG. 6 is a diagram for explaining the arrival direction of sound.

Each of the plurality of microphones 101 collects a speech sound emitted from a speaker. For example, in the example illustrated in FIG. 2, microphones 101-1 to 101-5 are disposed on the right temple 21, the right endpiece 22, the bridge 23, the left endpiece 24, and the left temple 25 of the display device 1, respectively. Microphones 101-1 to 101-5 collect speech sounds arriving via the paths shown in FIG. 5. The microphones 101-1 to 101-5 convert collected speech sounds into speech signals.

The processing shown in FIG. 4 is started at the timing when the power supply of the display device 1 is turned on and the initial setting is completed. However, the start timing of the processing illustrated in FIG. 4 is not limited thereto.

The controller 10 executes acquisition (S110) of the speech signal converted by the microphone 101.

To be specific, the processor 12 acquires a speech signal including a speech sound emitted from at least one of the speakers P2, P3, and P4 transmitted from the microphones 101-1 to 101-5. The speech signals transmitted from the microphones 101-1 to 101-5 include spatial information based on the path through which the speech sound has traveled.

After Step S110, the controller 10 executes estimation (S111) of the sound-arrival direction.

The storage device 11 stores a sound-arrival direction estimation model. The sound-arrival direction estimation model describes information for specifying a correlation between spatial information included in a speech signal and a sound-arrival direction of a speech sound.

Any existing method may be used as a sound-arrival direction estimation method used in the sound-arrival direction estimation model. For example, MUSIC (Multiple Signal Classification) using eigenvalue expansion of an input correlation matrix, a minimum norm method, ESPRIT (Estimation of Signal Parameters via Rotational Invariance Techniques), or the like is used as the sound-arrival direction estimation technique.

The processor 12 inputs the speech signals received from the microphones 101-1 to 101-5 to the sound-arrival direction estimation model stored in the storage device 11 to estimate the directions of arrival of the speech sounds collected by the microphones 101-1 to 101-5. At this time, for example, the processor 12 expresses the sound-arrival direction of the speech sound by an argument from an axis in which a reference direction (in the present embodiment, the front direction of the user wearing the display device 1) determined with reference to the microphones 101-1 to 101-5 is set to 0 degree. In the example illustrated in FIG. 6, the processor 12 estimates that the sound-arrival direction of the speech sound emitted from the speaker P2 is an angle A1 in the right direction from the axis. The processor 12 estimates that the sound-arrival direction of the speech sound emitted from the speaker P3 is an angle A2 in the left direction from the axis. The processor 12 estimates that the sound-arrival direction of the speech sound emitted from the speaker P4 is an angle A3 in the left direction from the axis.

After step S111, the controller 10 executes extraction (S112) of a speech signal.

The storage device 11 stores a beam forming model. In the beam forming model, information for specifying a correlation between a predetermined direction and a parameter for forming directivity having a beam in the direction is described. Here, the formation of directivity is a process of amplifying or attenuating sound in a specific incoming direction.

The processor 12 calculates a parameter for forming directivity having a beam in the sound-arrival direction by inputting the estimated sound-arrival direction to the beam forming model stored in the storage device 11.

In the example shown in FIG. 6, the processor 12 inputs the calculated angle A1 to the beam forming model and calculates parameters for forming a directivity having a beam in the direction of the angle A1 in the right direction from the axis. The processor 12 inputs the calculated angle A2 to the beam forming model and calculates parameters for forming a directivity having a beam in the direction of the angle A2 in the left direction from the axis. The processor 12 inputs the calculated angle A3 to the beam forming model and calculates parameters for forming a directivity having a beam in the direction of the angle A3 in the left direction from the axis.

The processor 12 amplifies or attenuates the speech signals transmitted from the microphones 101-1 to 101-5 with the parameter calculated for the angle A1. The processor 12 combines the amplified or attenuated speech signals to extract, from the received speech signal, a speech signal of the speech sound coming from the angle A1.

The processor 12 amplifies or attenuates the speech signals transmitted from the microphones 101-1 to 101-5 with the parameter calculated for the angle A2. The processor 12 combines the amplified or attenuated speech signals to extract, from the received speech signal, a speech signal of the speech sound coming from the angle A2.

The processor 12 amplifies or attenuates the speech signals transmitted from the microphones 101-1 to 101-5 with the parameter calculated for the angle A3. The processor 12 combines the amplified or attenuated speech signals to extract, from the received speech signal, a speech signal of the speech sound coming from the angle A3.

After Step S112, the controller 10 executes speech recognition processing (S113).

A speech recognition model is stored in a storage device 11. In the speech recognition model, information for specifying a correlation between a speech signal and a text corresponding to the speech signal is described. The speech recognition model is, for example, a learned model generated by machine learning.

The processor 12 inputs the extracted speech signal to the speech recognition model stored in the storage device 11 to determine a text corresponding to the input speech signal.

In the example illustrated in FIG. 6, the processor 12 inputs the speech signals extracted for the angles A1 to A3 to the speech recognition model, and thereby determines the text corresponding to the input speech signals.

After Step S113, the controller 10 executes image generation (S114).

Specifically, the processor 12 generates a text image representing the determined text.

After step S114, the controller 10 executes determination (S115) of the display aspect.

Specifically, the processor 12 determines how to display a display image including a text image on the display 102.

After Step S115, the controller 10 executes image display (S116).

Specifically, the processor 12 displays a display image corresponding to the determined display aspect on the display 102.

### (4) Display Example of Display Device

Hereinafter, an example of a display image according to the determination of the display aspect in step S115 will be described in detail. The processor 12 determines the display position of the text image on the display unit of the display device 1 based on the estimated incoming direction of the speech and the adjustment amount determined based on the detection result of at least one of the operation by the user and the state of the display device 1.

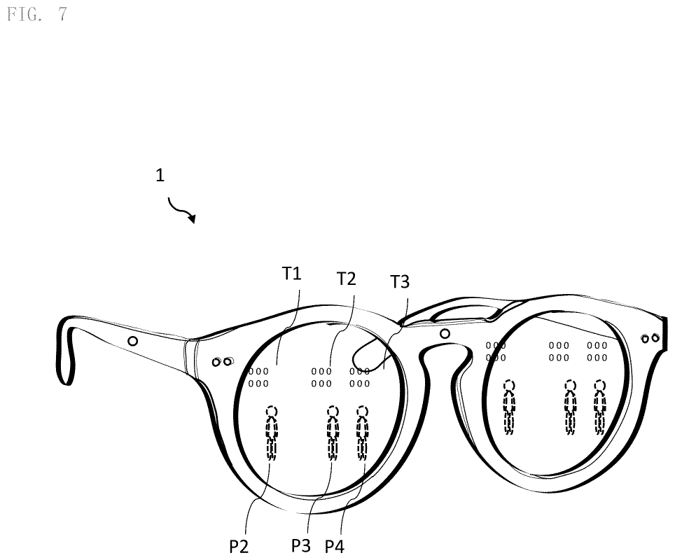

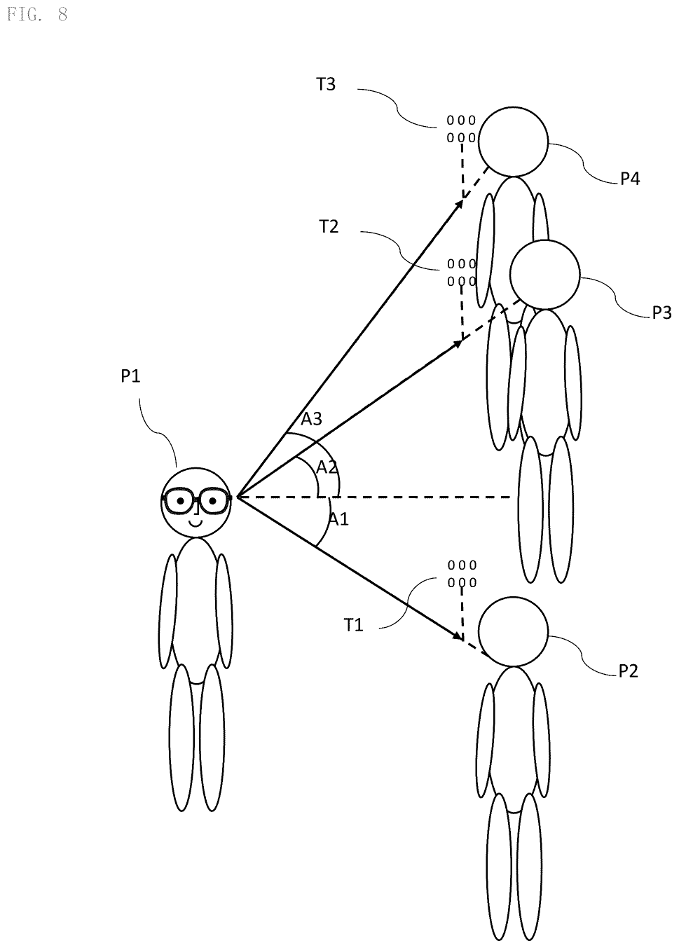

First, the display position of the text image in the horizontal direction will be described. FIG. 7 is a diagram illustrating a display example in the display device. FIG. 8 is a diagram for explaining how the wearer looks in the field of view. Here, the images of the speakers P2 to P4 drawn by the broken lines in FIG. 7 represent real images that pass through the display 102 and are seen by the eyes of the user P1, and are not included in the image displayed on the display 102. The text images T1 to T3 depicted in FIGS. 9A to 9B represent images displayed on the display 102 and seen by the eyes of the user P1, and do not exist in the real space. Note that the field of view seen through the display 102-1 and the field of view seen through the display 102-2 are different in image position from each other in accordance with parallax.

As illustrated in FIGS. 7 and 8, the processor 12 determines the position corresponding to the sound-arrival direction of the speech signal related to the text image as the display position of the text image. More specifically, the processor 12 determines the display position of the text image A1 corresponding to the sound (the speech sound of the speaker P2) arriving from the direction of the angle T1 with respect to the display device 1 to be a position seen in the direction corresponding to the angle A1 when viewed from the viewpoint of the user P1.

The processor 12 determines the display position of the text image A2 corresponding to the sound (the speech sound of the speaker P3) arriving from the direction of the angle T2 with respect to the display device 1 to be a position seen in the direction corresponding to the angle A2 when viewed from the viewpoint of the user P1.

The processor 12 determines the display position of the text image A3 corresponding to the sound (the speech sound of the speaker P4) arriving from the direction of the angle T3 with respect to the display device 1 to be a position seen in the direction corresponding to the angle A3 when viewed from the viewpoint of the user P1.

Here, the angles A1 to A3 represent azimuth angles.

In this manner, the text images T1 to T3 are displayed on the display 102 at display positions corresponding to the incoming directions of the speeches. As a result, the text image T1 representing the speech content of the speaker P2 is presented to the user P1 of the display device 1 together with the image of the speaker P2 visually recognized through the display 102. In addition, the text image T2 representing the speech content of the speaker P3 is presented to the user P1 together with the image of the speaker P3 visually recognized through the display 102. In addition, the text image T3 representing the speech content of the speaker P4 is presented to the user P1 together with the image of the speaker P4 visually recognized through the display 102. When the orientation of the display device 1 (i.e., the orientation of the face of the user P1) is changed, the display position of the text image on the display 102 is similarly changed so that the image of the speaker and the text image of the content of the speech appear in the same direction when viewed from the user P1. That is, the display position in the horizontal direction of the text image displayed on the display 102 is determined in accordance with the estimated incoming direction and the orientation of the display device 1.

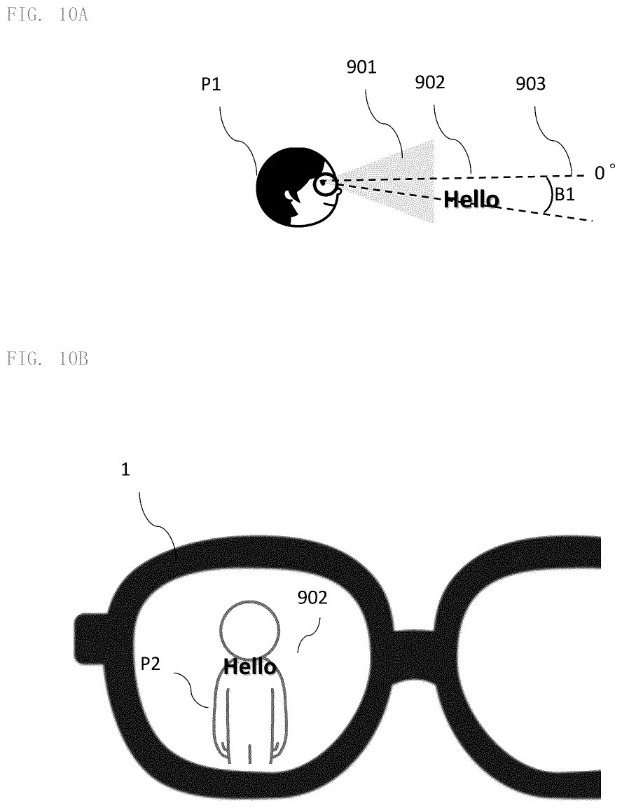

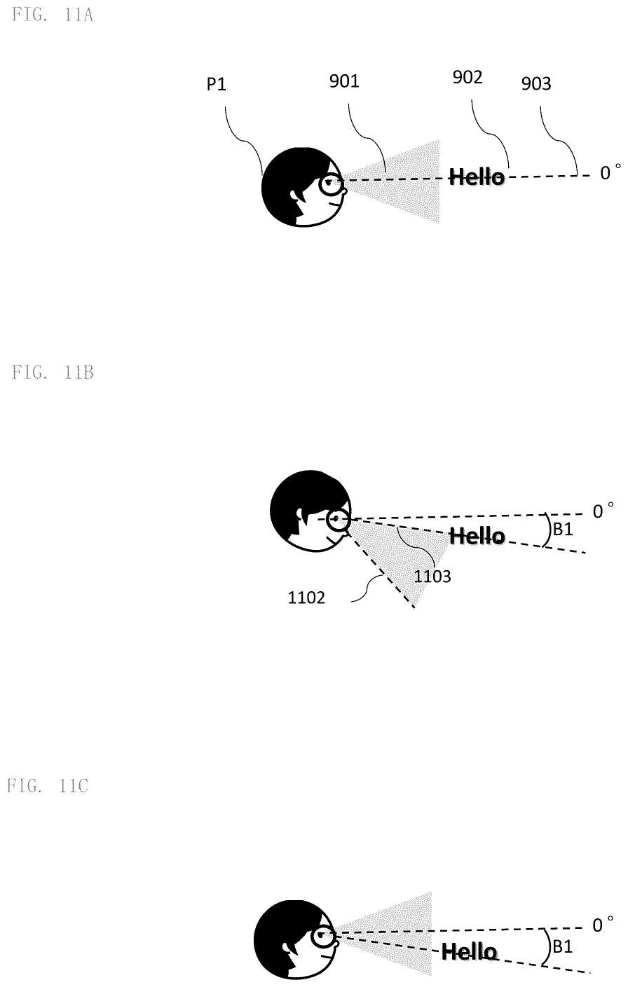

Next, the display position of the text image in the vertical direction will be described. The elevation angle of the direction in which the text image displayed on the display 102 can be seen from the viewpoint of the user P1 wearing the display device 1 is determined in accordance with the adjustment amount determined by the processor 12. FIGS. 9A to 9B are diagrams illustrating how the wearer looks in the field of view before the display position adjustment. FIGS. 10A to 10B are diagrams illustrating how the wearer looks in the field of view after the display position adjustment. FIGS. 11A to 11C are diagrams illustrating an example of a method of adjusting the display position.

FIG. 9A conceptually illustrates a relationship among a user P1, a field of view (FOV) 901 of the display device 1, a horizontal-direction 903, and a display position of a text image 902 obtained by converting a speech of “hello” by a speaker P2 into text. A field of view (FOV) 901 is an angle range preset in the display device 1, and has a predetermined width in each of an elevation angle direction and an azimuth angle direction with respect to a reference direction (a front direction of a wearer) of the display device 1. The FOV of the display device 1 is included in the field of view that the user is looking through the display device 1. FIG. 9B shows a part of the field of view of the user P1 in the situation shown in FIG. 9A.

As illustrated in FIGS. 9A and 9B, in a state where the adjustment amount of the display position is set to the initial value, the display position is determined such that the text image 902 appears at a position corresponding to the horizontal direction when viewed from the viewpoint of the user P1. That is, when viewed from the viewpoint of the user P1, the elevation angle of the direction in which the text image displayed on the display 102 with respect to the horizontal direction is 0°.

Here, in a case where the height of the eye line of the user P1 is the same as the height of the eye line of the speaker P2, the text image 902 and the image of the speaker P1 overlap with each other from the user P2. According to such display, although it is easy for the user P1 to recognize who is the speaker of the text image 902, the expression of the speaker P2 is hidden by the text image 902 and is difficult to see.

On the other hand, as illustrated in FIGS. 10A and 10B, in a state in which the adjustment amount of the display position is changed, the display position is determined such that the text image 902 is seen below the corresponding position in the horizontal direction when viewed from the viewpoint of the user P1. That is, the elevation angle of the direction in which the text image displayed on the display 102 can be seen from the viewpoint of the user P1 is −B1 (i.e., the depression angle is +B1). As described above, by adjusting the display position of the text image in the vertical direction on the display 102, it is possible to prevent the expression of the speaker P2 from being hidden by the text image 902, and thus the user P1 can smoothly communicate with the speaker P2.

The adjustment amount of the display position of the text image is determined based on, for example, a user operation detected by the operation unit 105. To be specific, in a case where the operation unit 105 is a touch display installed in the display device 1, when a touch operation is performed on the operation unit 105 by the user P1, the controller 10 determines an adjustment amount in accordance with an input from the operation unit 105. When the elevation angle −B1 is set as the adjustment amount by the controller, even if the orientation of the display device 1 (i.e., the orientation of the face of the user P1) is changed, the elevation angle of the direction in which the text image can be seen from the viewpoint of the user P1 is −B1. That is, the display position in the vertical direction of the text image displayed on the display 102 is determined according to the adjustment amount determined by the controller 10 and the orientation of the display device 1.

Further, for example, the adjustment amount of the display position of the text image is determined based on the state of the display device 1 detected by the sensor 104. To be more specific, in the case where the sensor 104 is a sensor that detects the inclination of the display device 1, when the user P1 wearing the display device 1 faces downward, the depression angle of the inclination of the display device 1 increases. Accordingly, the downward adjustment amount of the display position of the text image 902 on the display 102 is increased. FIG. 11A illustrates a state where the user P1 faces the front and the adjustment amount of the display position is the initial value. FIG. 11B illustrates a state in which the user P1 faces downward from the state illustrated in FIG. 11A and the adjustment amount of the display position is changed. FIG. 11C illustrates a state in which the user P1 faces the front again from the state illustrated in FIG. 11B and the adjustment amount of the display position is maintained at the value set in the state illustrated in FIG. 11B.

In one example, the processor 12 updates the adjustment amount of the display position based on the following (Equation 1) and (Equation 2).

Ψ=min(ψᵤ,ψ) (Equation 1)

Ψ=max(ψₗ,ψ) (Equation 2)

Here, ψ is an angle corresponding to the adjustment amount of the display position of the text image in the vertical direction, ψᵤ is an angle indicating the direction of the upper end 1103 of the FOV901, and ψₗ is an angle indicating the direction of the lower end 1102 of the FOV901.

(Equation 1) means that when the user P1 faces downward (when the depression angle of the display device 1 increases), the display position of the text image 902 is lowered so that the text image 902 does not deviate from the FOV901. (Equation 2) means that when the user P1 faces upward (when the elevation angle of the display device 1 increases), the display position of the text image 902 is moved upward so as not to deviate from the FOV901. When the inclination in the elevation angle direction of the display device 1 is within a predetermined range, the adjustment amount related to the display position in the vertical direction of the text image on the display 102 is not changed, and when the inclination in the elevation angle direction of the display device 1 exceeds the predetermined range, the adjustment amount is changed. The case where the inclination of the display device 1 in the elevation angle direction is within the predetermined range is a case where the position of the text image 902 is in contact with neither the upper end nor the lower end of the FOV901. That is, the predetermined range is determined based on the elevation angle with respect to the horizontal direction 903 of the direction in which the text image 902 displayed on the display 102 can be seen from the viewpoint of the user P1 wearing the display device 1.

As described above, according to the configuration in which the adjustment amount of the display position of the text image is determined in accordance with the inclination of the display device 1, the user P1 can change the display position of the text image to a desired position only by moving the face direction up and down. As a result, the user P1 does not need to perform a complicated operation for changing the display position of the text image, and communication by the user P1 can be facilitated.

### (5) Summary

According to the present embodiment, the controller 10 determines the adjustment amount of the display position of the text image on the display unit of the display device 1 based on the detection result of at least one of the operation by the user and the state of the display device 1. Then, the controller 10 displays the text image generated by the speech recognition at a position determined according to the estimated incoming direction of the speech and the determined adjustment amount. As a result, the wearer of the display device 1 can easily recognize in which direction the displayed text image represents the speech of the person, and can simultaneously recognize both the important real object such as the face of the speaker and the text image. As a result, communication by the user can be made smooth.

Further, according to the present embodiment, the display device 1 is a display device that can be worn by a user. Then, the controller 10 determines the adjustment amount related to the display position in the vertical direction of the text image on the display unit based on the inclination in the elevation angle direction of the display device 1. Thus, the user can adjust the display position of the text image by a simple gesture of moving the direction of the face.

### (6) Modifications

Modifications of the present embodiment will be described.

### (6.1) Modification 1

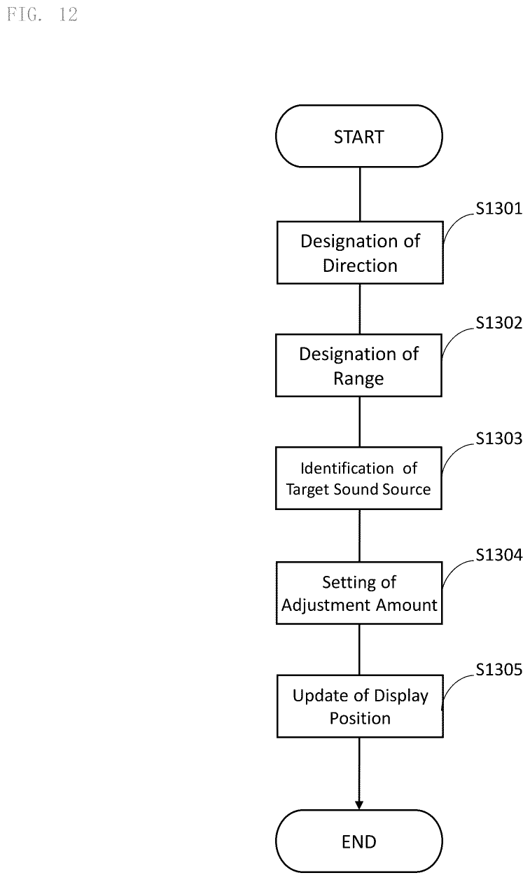

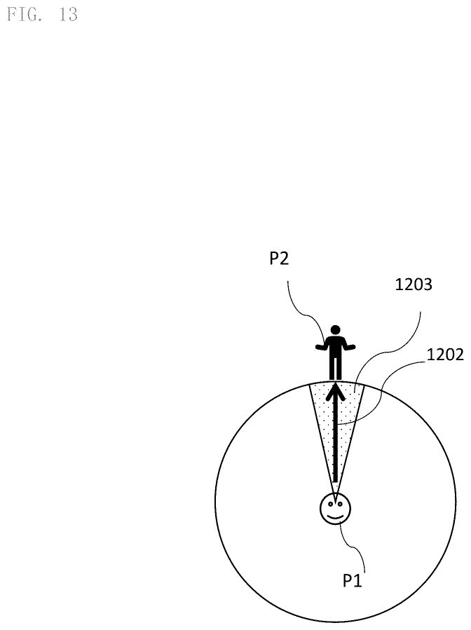

A modification 1 of the present embodiment will be described. In the modification 1, an example is described in which the adjustment amount of the display position of the text image is set for each target region. FIG. 12 is a flowchart illustrating an example of processing related to adjustment of a display position. FIG. 13 is a diagram for explaining a method of specifying an adjustment target of the display position.

The processing of FIG. 12 is executed at a timing when an instruction corresponding to an operation or a gesture by the user for setting the adjustment amount of the display position is input to the display device 1. However, the execution timing of the processing in FIG. 12 is not limited thereto. The processing shown in FIG. 12 can be executed in parallel with the processing shown in FIG. 4.

In the S1301, the controller 10 designates a target direction serving as a reference of an adjustment target of the text display position. Specifically, the processor 12 designates a target direction based on a user operation. As illustrated in FIG. 13, when the user P1 of the display device 1 wants to adjust the display position of the text image corresponding to the utterance of the speaker P2, the user P1 performs an operation of designating a target direction 1202 which is a direction in which the speaker P2 is present. The operation by the user may be, for example, a touch operation performed on the operation unit 105 in a state of facing in the target direction. Note that the method of determining the target direction is not limited to this. For example, a specific direction based on the orientation of the display device 1 may be predetermined as the target direction.

In the S1302, the controller 10 designates a target range in which the text display position is to be adjusted. To be specific, when the user P1 performs an operation of designating an angular range with respect to the target direction 1202, the processor 12 designates the target range 1203 based on the user operation. When the user does not instruct the angular range, the processor 12 specifies the target range 1203 based on the angular range set as a default value and the target direction 1202. Alternatively, the processor 12 may designate the target range 1203 on the basis of at least one of the position of a sound source in the vicinity of the target direction 1202, the number of sound sources, and a fluctuation in the arrival direction of sound so that a sound source present in the vicinity of the target direction 1202 is included in the target range 1203.

In the S1303, the controller 10 specifies a target sound source to be an adjustment target of the text display position. Specifically, the processor 12 specifies, as the target sound source, a sound source existing in the target range 1203 among the sound sources recognized based on the estimation result of the sound-arrival direction of the speech.

In the S1304, the controller 10 sets the adjustment amount of the text display position. The method of setting the adjustment amount is the same as that in the above-described embodiment.

In the S1305, the controller 10 updates the display position of the text image based on the set adjustment amount. To be specific, the processor 12 updates the display position of the text image corresponding to the sound source specified in the S1303 based on the set adjustment amount. That is, the display position of the text image corresponding to the speech coming from the direction included in the target range 1203 designated by the S1302 is updated based on the adjustment amount. On the other hand, the display position of the text image corresponding to the speech arriving from the direction not included in the target range 1203 is not updated.

According to the configuration of the present modification, when the difference between the target direction and the estimated sound-arrival direction of the speech is less than the threshold value, the adjustment amount of the display position of the text image corresponding to the sound-arrival direction is determined based on the detection result of at least one of the user operation and the state of the display device 1. Accordingly, the user can adjust the display position of the text image corresponding to the specific sound source independently of the display positions of the text images corresponding to the other sound sources. For example, when a plurality of speakers having greatly different heights are present around the user, the user can adjust the display position so that the text image corresponding to the speech of the speaker is displayed at a position of a height corresponding to the height of the speaker on the display unit of the display device 1. As a result, it becomes easy for the user to communicate while viewing both the expression of the speaker and the text image.

The controller 10 can also set a different adjustment amount for each target range by performing the process of FIG. 12 a plurality of times and designating a plurality of target ranges. In this case, the controller 10 can set a different adjustment amount for each sound source by specifying each target range to be narrow. In addition, the controller 10 can uniformly set the adjustment amount of the display position of the text image in all incoming directions by specifying the angular range of the target range to 360 degrees.

### (6.2) Other Modifications

In the above-described embodiment, the case where the plurality of microphones 101 are integrated with the display device 1 has been mainly described. However, the present disclosure is not limited to this, and an array microphone device having a plurality of microphones 101 may be configured as a separate body from the display device 1 and connected to the display device 1 in a wired or wireless manner. In this case, the array microphone device and the display device 1 may be directly connected to each other or may be connected to each other via another device such as a PC or a cloud server.

When the array microphone apparatus and the display device 1 are configured as separate bodies, at least a part of the above-described functions of the display device 1 may be implemented in the array microphone apparatus. For example, the array microphone device may execute the estimation of the sound-arrival direction in S111 and the extraction of the speech signal in S112 in the processing flow of FIG. 4, and transmit the information indicating the estimated sound-arrival direction and the extracted speech signal to the display device 1. Then, the display device 1 may control display of an image including a text image using the received information and the speech signal.

In the above-described embodiment, the case where the display device 1 is an optical see-through glass type display device has been mainly described. However, the form of the display device 1 is not limited thereto. For example, the display device 1 may be a video see-through glass type display device. That is, the display device 1 may comprise a camera. Then, the display device 1 may cause the display 102 to display a composite image obtained by combining the text image generated based on the speech recognition and the captured image captured by the camera. The captured image is an image obtained by capturing a front direction of the user, and may include an image of a speaker. In addition, for example, the controller 10 and the display 102 may be configured as separate bodies such that the controller 10 is present in a cloud server.

In the above-described embodiment, the case where the display position of the text image in the horizontal direction on the display unit of the display device 1 is determined based on the estimation result of the sound-arrival direction of the speech, and the display position of the text image in the vertical direction is determined based on the above-described adjustment amount has been mainly described. However, the present disclosure is not limited thereto, and the above-described adjustment amount may be used to determine the display position of the text image in the horizontal direction.

For example, in a case where there is a deviation between the sound-arrival direction of the speech estimated by the display device 1 and the direction of the sound source viewed from the user, the display position of the text image in the horizontal direction may be adjusted based on the adjustment amount set by the same method as that of the above-described embodiment. As a result, the above-described deviation can be reduced. In addition, the display position of the text image in the horizontal direction may be intentionally shifted so that the image of the sound source and the text image do not overlap each other when viewed from the user. At this time, the controller 10 performs control such that the text image is displayed at a position shifted in the horizontal direction by a distance corresponding to the adjustment amount from the position calculated in accordance with the incoming direction of the speech.

In addition, the controller 10 may estimate the elevation angle of the sound-arrival direction of the speech in the same manner as estimating the azimuth angle of the sound-arrival direction of the speech as in the above-described embodiment. Then, the controller 10 may determine the display position of the text image on the display device 1 based on the estimated elevation angle of the sound-arrival direction. Further, the controller 10 may perform control such that the text image is displayed at a position shifted in the vertical direction by a distance corresponding to the adjustment amount from the position calculated in accordance with the sound-arrival direction of the speech.

In the above-described embodiment, an example in which a user's instruction is input from the operation unit 105 connected to the input/output interface 13 has been described, but the present disclosure is not limited thereto. The user's instruction may be input from a driving button object presented by an application of a computer (for example, a smartphone) connected to the communication interface 14.

The display 102 may be realized by any method as long as it can present an image to the user. The display 102 can be implemented by, for example, the following implementation method:
A holographic optical element (HOE) or a diffractive optical element (DOE) using an optical element (for example, a light guide plate);
Liquid crystal display;
Retinal projection display;
LED (Light Emitting Diode) display;
Organic EL (Electro Luminescence) display;
Laser display; and
A display that guides light emitted from a light emitting body using an optical element (for example, a lens, a mirror, a diffraction grating, a liquid crystal, a MEMS mirror, or an HOE).

In particular, a retinal projection display allows even a weak-sighted person to easily observe an image. Therefore, it is possible to cause a person suffering from both hearing loss and amblyopia to more easily recognize the sound-arrival direction of the speech sound.

In the speech extraction process performed by the controller 10, any method may be used as long as a speech signal corresponding to a specific speaker can be extracted. The controller 10 may extract the speech signal by, for example, the following method:
Frost beamformer;
Adaptive filter beamforming (generalized sidelobe canceller as an example); and
Speech extraction methods other than beamforming (as an example, a frequency filter or machine learning)

Although the embodiments of the present invention have been described in detail above, the scope of the present invention is not limited to the above-described embodiments. Various improvements and modifications can be made to the above-described embodiment without departing from the gist of the present invention. Further, the above-described embodiments and modifications can be combined.

According to the above disclosure, display method can be provided which is highly convenient for a user in a display device that displays a text image corresponding to a voice within a visual field of the user.

### REFERENCE SIGNS LIST

1: display device
10: controller
101: microphone
102: display
104: Sensor
105: operation unit

1. A display control apparatus that controls display of a display device wearable by a user, the display control apparatus comprising:
a memory that stores codes; and
a processor that executes the codes stored in the memory to:
acquire speech collected by a plurality of microphones;
estimate a sound-arrival direction of the acquired speech;
generate a text image corresponding to the acquired speech;
determine an adjustment amount of a display position of a text image on a display unit of the display device based on a detection result of at least one of an operation by the user and a state of the display device; and
display the generated text image at a display position in the display unit, the display position being determined according to the estimated sound-arrival direction and the determined adjustment amount.

2. The display control apparatus according to claim 1, wherein the display device is a glass type display device that can be worn by the user.

3. The display control apparatus according to claim 1, wherein an elevation angle with respect to a horizontal direction of a direction in which the text image displayed on the display unit is seen from a viewpoint of the user wearing the display device is determined according to the determined adjustment amount.

4. The display control apparatus according to claim 1, wherein the state of the display device includes a tilt of the display device detected by a sensor included in the display device.

5. The display control apparatus according to claim 4, wherein the processor determines the adjustment amount related to the display position of the text image in the vertical direction on the display unit based on the inclination of the display device in an elevation angle direction.

6. The display control apparatus according to claim 5, wherein the processor increases a downward adjustment amount of the display position of the text image on the display unit in accordance with an increase in a depression angle of the inclination of the display device.

7. The display control apparatus according to claim 5, wherein the processor does not change the adjustment amount related to the display position of the text image in the vertical direction on the display unit when the inclination of the display device in an elevation direction is within a predetermined range, and changes the adjustment amount when the inclination of the display device in the elevation direction exceeds the predetermined range.

8. The display control apparatus according to claim 7, wherein the predetermined range is determined based on an elevation angle with respect to a horizontal direction of a direction in which the text image displayed on the display unit is seen from a viewpoint of a user wearing the display device.

9. The display control apparatus according to claim 1, wherein
a display position in a vertical direction of the text image displayed on the display unit is determined in accordance with the determined adjustment amount and an orientation of the display device, and
a display position in the horizontal direction of the text image displayed on the display unit is determined according to the estimated sound-arrival direction and the orientation of the display device.

10. The display control apparatus according to claim 1, the processor identifies a target direction, and wherein
when a difference between the identified target direction and the estimated sound-arrival direction is less than a threshold value, the processor determines the adjustment amount of the display position of the text image corresponding to the sound-arrival direction based on the detection result.

11. The display control apparatus according to claim 1, wherein the operation by the user includes a touch operation on the display device.

12. The display control apparatus according to claim 1, wherein the processor generates a text image corresponding to the acquired speech by performing speech recognition processing on the speech.

13. A non-transitory computer-readable recording medium that stores a program which causes a computer to execute a method comprising:
acquiring speech collected by a plurality of microphones;
estimating a sound-arrival direction of the acquired speech;
generating a text image corresponding to the acquired speech;
determining an adjustment amount of a display position of a text image on a display unit of the display device based on a detection result of at least one of an operation by the user and a state of the display device; and
displaying the generated text image at a display position in the display unit, the display position being determined according to the estimated sound-arrival direction and the determined adjustment amount.

14. A display control method for controlling display of a display device wearable to a user, the display control method comprising:
acquiring speech collected by a plurality of microphones;
estimating a sound-arrival direction of the acquired speech;
generating a text image corresponding to the acquired speech;
determining an adjustment amount of a display position of a text image on a display unit of the display device based on a detection result of at least one of an operation by the user and a state of the display device; and
displaying the generated text image at a display position in the display unit, the display position being determined according to the estimated sound-arrival direction and the determined adjustment amount.
